(19) United States
(12) Patent Application Publication
(10) Pub. No.: US 2013/0103504 A1
(43) Pub. Date: Apr. 25, 2013

(54) System for Displaying Advertisements on a Display Monitor at Traffic Signals

(71) Applicants: Lakshminarayan Srinivasan, Houston, TX (US); Lee M. McAdory, Katy, TX (US); Jeremy Srinivasan, Katy, TX (US)

(72) Inventors: Lakshminarayan Srinivasan, Houston, TX (US); Lee M. McAdory, Katy, TX (US); Jeremy Srinivasan, Katy, TX (US)

(21) Appl. No.: 13/442,800

(22) Filed: Apr. 9, 2012

Related U.S. Application Data
(63) Continuation-in-part of application No. 11/183,141, filed on Jul. 15, 2005, now abandoned.

(51) Int. Cl. G06Q 30/02

(52) U.S. Cl. CPC G06Q 30/0241
USPC 705/14.68; 705/14.4

(57) ABSTRACT

A system is disclosed for displaying advertisements on a plurality of display monitors where each display monitor is associated with and mechanically coupled to a traffic signal. The system includes a plurality of display computers where each display computer is operatively connected to one of the display monitors for providing video or other digital content information to the display monitor to be displayed. A wide area network is operatively coupled to the display computer for use in transmitting video and other information to the display computer. A local area network provides video and other information to the display computers via the wide area network, and a router is operatively connected between the local area and wide area networks for directing information from the local area network to said display computers. The system has a display (preferably rectangular) that displays the traffic signal in the same frame as the advertisement display.

### CROSS-REFERENCE TO RELATED APPLICATIONS

This application is a continuation-in-part of U.S. application Ser. No. 11/183,141, filed Jul. 15, 2005.

### BACKGROUND OF THE INVENTION

1. Field of the Invention

The present invention relates to a system for use in displaying advertisements on a display monitor attached to a traffic signal.

2. Description of the Prior Art

Every major metropolitan city has a plethora of traffic signals, and these traffic signals perform the function of controlling the flow of vehicular and pedestrian traffic. It would be advantageous to utilize the traffic signal apparatus in connection with the performance of other functions, especially when vehicular and/or pedestrian traffic has come to a stop because of the traffic light on the traffic signal being red in the direction of the pedestrian and/or vehicular traffic. In particular, it would advantageous to be able to display advertisements at the site of traffic signals when the traffic signal has a red light in the direction of the travel. However, to applicants' knowledge, no such system exists.

U.S. Pat. No. 5,917,431 suggested the possibility of a display system for a traffic signal. The display system disclosed in U.S. Pat. No. 5,917,431 comprises a small local area network to which the displays are connected, and it does not describe any way to receive any new data. Additionally, the system described in U.S. Pat. No. 5,917,431 is one in which a memory chip is used for holding data to be displayed, and that system does not describe any way to receive new data. Thus, the system disclosed in U.S. Pat. No. 5,917,431 displays the same information at all times.

U.S. Pat. No. 5,150,116 (West) discloses a traffic light timed advertising center that includes an advertising display device, such as an electronic message center or other visual display device for displaying alpha-numeric and symbolic advertising messages, in which the advertising messages can be made selectively visible and invisible to drivers, is positioned adjacent a traffic control signal device having alternative signal phases for sequentially stopping and permitting the flow of traffic. A display control device, including an electronic control signal, coordinates the advertising display device with the traffic control signal device to make the advertising message invisible to drivers at selected times, particularly during transitions of the traffic control signal device from one signal phase to another, during a particular phase, and for predetermined time intervals before or after the transition from one phase to another, as desired or appropriate to display the advertising message only during times of the traffic control signal device phases when drivers' attentions to the advertising message will not adversely affect the drivers' attentions to required driving functions. FIG. 4 shows an alternative embodiment wherein the traffic light timed advertising center and the traffic light itself are incorporated into an integral, unitary electronic message center such that the red light, yellow light, and green light will merely appear as an additional message center display along with the advertising display on the message center. However, a disadvantage to this configuration, as shown in FIG. 4, is that the traffic signal appears at a location to the far, outermost edge of the message center, in an “L-shaped” fashion where the remainder of the display progresses horizontally across the span of the light pole arm thereby providing a visual distraction diverting the viewer's eyes away from the signal light.

U.S. Pat. No. 6,813,554 (Ebert) discloses an apparatus and methods suited to add commercial value to traffic control systems. A computer device is provided that allows connections with a computer network, external sensors or external devices, and a traffic control system. Combinations of the features of the connected components result in a variety of commercially valuable implementations.

U.S. Pat. No. 6,145,089 (Le, et al.) discloses a method and apparatus for a server fail-over system is provided. The fail-over system includes a plurality of servers for providing a plurality of services. Each server may provide more than one service. The plurality of servers includes a first server for providing a first service, the system further including a client for consuming the plurality of services, including the first service. A network connects the client to the plurality of servers. If the first server fails to provide the first service, the first service fails over to a second server of the plurality of servers, the second server of the plurality of servers being the highest priority server for providing the first service in the event of failure of the first server.

U.S. Pat. No. 5.917,431 (Sanada, et al.) discloses a traffic signal (TS) panel that can be easily observed with the traffic signal. Multiple pieces of information are changed over to be displayed on the TS panel, and a luminescent color of the information such as traffic condition reports, traffic slogans, advertisements, etc. or a luminescent color of the background of the information is illuminated in the same color as that of a the turned-on light of the signal. A detector detects whether each lamp is turned on or not without modifying an electric circuit of the signal. Then, multiple pieces of information are sequentially changed over in synchronism with a changeover of a turned-on color of the signal in accordance with a detection signal output from the detector, and the luminescent color of the background is changed over to be of a color which is the same color as that of the light currently turned on. As a result, various information can be displayed on the TS panel, and a signal color can be recognized not only by a signal lamp but also a display color of the TS panel.

It would be advantageous to have a traffic light display system for displaying advertisements that are part of a wide area network allowing the displays to receive data and updates remotely and which utilize computers to contact and receive data from centrally located servers. It would be further advantageous to have a system that is capable of receiving and storing new advertising data for display as well as schedules for the display of such advertisements. It would be further advantageous to have a system that has a streamlined display that displays the traffic signal in the same rectangular frame (or oval, circular, etc.) as the advertisement display. These advantageous results have been achieved with the system of the present invention.

### SUMMARY OF THE INVENTION

In accordance with the present invention, a system is provided for displaying advertisements on a plurality of display monitors where each of the display monitors is associated with a traffic signal. The system comprises a plurality of display computers and a display computer is operatively connected to one of the display monitors for providing video or other digital content information which is to be displayed on that display monitor. A wide area network is operatively coupled to the plurality of display computers and the wide area network is utilized in transmitting video and other digital content information to the display computers. A local area network is operatively connected to the wide area network via a router to provide video and other digital information to the display computers via the wide area network. The router is operatively connected between the local area network and the wide area network and directs the video and other digital information from the local area network to at least one of the display computers.

In accordance with the present invention, the local area network comprises a plurality of servers. A first server [data server] comprises a plurality of storage devices for storing files comprising the video information which is to be transferred to at least one of the display computers and which is to be displayed on the display monitor associated with the computer. A system in accordance with the present invention further comprises a second server [database server] which contains files comprising the schedule for displaying files containing the video information. A system in accordance with the present invention may further comprise a third server [heartbeat server] for receiving information from the display computers and for processing that information to ensure that the display computers are functioning properly.

In accordance with the present invention, each of the display computers includes programming to allow the display computer to: (a) interrogate the database in the second server [database server] for the time and date for the video or other digital information to be displayed, the name of the video or other digital file to be displayed and location on the first server [data server] of the video or other digital file to be displayed; (b) retrieve video files from the first server based on the information received from the second server; and (c) display the retrieved files on the display monitor that is associated with that display computer.

A system in accordance with the present invention further comprises a plurality of user computers which provide the information to the second server respecting schedules for display of the advertisements and which provide information to the first server respecting the video or other digital content information which is to be displayed.

In a system in accordance with the present invention, each user computer includes programming to allow the user computer to: (a) receive input from a user respecting the time and date to display a given video or digital content file on a particular display monitor; (b) provide information for storage in the database of the second server [database server] respecting the time and date for the video file to be displayed, the name of the video or other digital content file to be displayed and location on the first server [data server] of the video file to be displayed and the name of the display computer on which to display the video file; and (c) provide the storage devices of the first server with the video file to be displayed on one of the display monitors.

Each user computer in a system in accordance with the present invention may further be programmed to interrogate the information in the database of the second server respecting schedules of display of video or other digital information and to display that information on the user computer. Each user computer may further be programmed to retrieve files respecting video information to be displayed from the first server and to display those files on the user computer.

The system further comprises one or more traffic signal display monitors, each monitor comprising a display monitor housing and one or more display screens for displaying advertising content from an advertising content display section and traffic signals from a traffic signal display content section proximate the advertising content display section.

In one embodiment of the system, the display monitor housing is substantially rectangular in shape defined by a vertical height and horizontal width, the advertising content display section occupying an upper portion of the monitor housing across the entire width of the housing, the traffic signal display content section residing within the housing below the advertising content display section. The traffic signal display section may be modularly mounted within the housing and the advertising content display section may be modularly mounted within the housing and separated from the traffic signal display section by a divider partition.

In another embodiment, the traffic signal display section and the advertising content display section are displayed on the same display screen within the housing. In yet another embodiment, the traffic signal display section and the advertising content display section are displayed on different display screens within the housing.

The system may further comprise one or more additional content display sections within the housing, the additional content display sections being displayed on the one or more display screens.

The system may also further comprise an additional content display section within the housing next to the traffic signal display section, the additional content display section being displayed on the one or more display screens.

In one embodiment of the system, the traffic signal display section further comprises an existing traffic control signal mounted within the housing.

In another embodiment of the system, the traffic signal display section further comprises separate display modules for displaying each of the respectively colored traffic signals.

In yet another embodiment of the system, the display monitor housing is substantially rectangular in shape, substantially oval in shape, or substantially circular in shape.

The content displayed on the display screens can be video, still digital images, or other advertising or informational content in formats capable of being electronically displayed.

### BRIEF DESCRIPTION OF THE DRAWINGS

FIG. 1 is a schematic diagram in block diagram form of a system in accordance with the present invention.

FIG. 2A-1 illustrates a preferred traffic signal display of the present invention mounted to a traffic signal pole.

FIG. 2A-2 illustrates the traffic signal display of FIG. 2A-1, here, shown in use with all black background (shown here in greyscale) while displaying the green light.

FIG. 2B illustrates the traffic signal display of FIG. 2A-1, here, shown in use with all black background (shown here in greyscale) while displaying the yellow light.

FIG. 2C illustrates the traffic signal display of FIG. 2A-1, here, shown in use with all black background (shown here in greyscale) while displaying the red light.

FIG. 2D illustrates the traffic signal display of FIG. 2A-1, here, shown in use displaying the red light while also displaying desired advertising content, and optionally, additional content such as the time and temperature.

FIG. 3A illustrates an enlarged front face view of preferred traffic signal display of the present invention, such as that shown in FIG. 2A-1, wherein the display modularly houses the advertising section, traffic signal section and additional content section into the same display panel housing.

FIG. 3B-1 illustrates the traffic signal display of FIG. 3A, here, shown displaying the green light.

FIG. 3B-2 illustrates the traffic signal display of FIG. 3A, here, shown in use with all black background (shown here in greyscale) while displaying the green light.

FIG. 3C illustrates the traffic signal display of FIG. 3A, here, shown in use with all black background (shown here in greyscale) while displaying the yellow light.

FIG. 3D illustrates the traffic signal display of FIG. 3A, here, shown in use with all black background (shown here in greyscale) while displaying the red light.

FIG. 3E illustrates the traffic signal display of FIG. 3A, here, shown in use displaying the red light while also displaying desired advertising content, and optionally, additional content such as the time and temperature.

FIG. 4A illustrates an enlarged front face view of an alternative preferred traffic signal display of the present invention, such as that shown in FIG. 2A-1, wherein the display incorporates the advertising content section, traffic signal content section and additional content section into the same display screen.

FIG. 4B-1 illustrates the traffic signal display of FIG. 4A, here, shown displaying the green light.

FIG. 4B-2 illustrates the traffic signal display of FIG. 4A, here, shown in use with all black background (shown here in greyscale) while displaying the green light.

FIG. 4C illustrates the traffic signal display of FIG. 4A, here, shown in use with all black background (shown here in greyscale) while displaying the yellow light.

FIG. 4D illustrates the traffic signal display of FIG. 4A, here, shown in use with all black background (shown here in greyscale) while displaying the red light.

FIG. 4E illustrates the traffic signal display of FIG. 4A, here, shown in use displaying the red light while also displaying desired advertising content, and optionally, additional content such as the time and temperature.

FIG. 5A illustrates an enlarged front face view of an alternative preferred traffic signal display of the present invention, wherein the display incorporates the advertising content section module and traffic signal content section module into the same display screen housing.

FIG. 5B illustrates the traffic signal display of FIG. 5A, here, shown in use with all black background (shown here in greyscale) while displaying the green light.

FIG. 5C illustrates the traffic signal display of FIG. 5A, here, shown in use with all black background (shown here in greyscale) while displaying the yellow light.

FIG. 5D illustrates the traffic signal display of FIG. 5A, here, shown in use with all black background (shown here in greyscale) while displaying the red light.

FIG. 5E illustrates the traffic signal display of FIG. 5A, here, shown in use displaying the red light while also displaying desired advertising content.

FIG. 6A illustrates an enlarged front face view of an alternative preferred traffic signal display of the present invention, wherein the display incorporates the advertising content section and traffic signal content section into the same display screen.

FIG. 6B illustrates the traffic signal display of FIG. 6A, here, shown in use with all black background (shown here in greyscale) while displaying the green light.

FIG. 6C illustrates the traffic signal display of FIG. 6A, here, shown in use with all black background (shown here in greyscale) while displaying the yellow light.

FIG. 6D illustrates the traffic signal display of FIG. 6A, here, shown in use with all black background (shown here in greyscale) while displaying the red light.

FIG. 6E illustrates the traffic signal display of FIG. 6A, here, shown in use displaying the red light while also displaying desired advertising content.

FIG. 7A illustrates an enlarged front face view of preferred alternative traffic signal display of the present invention, similarly to FIG. 3A, wherein the display modularly houses the advertising section, individual modular traffic signal lights and additional content section into the same display panel housing.

FIG. 7B-1 illustrates the traffic signal display of FIG. 7A, here, shown displaying the green light.

FIG. 7B-2 illustrates the traffic signal display of FIG. 7A, here, shown in use with all black background (shown here in greyscale) while displaying the green light.

FIG. 7C illustrates the traffic signal display of FIG. 7A, here, shown in use with all black background (shown here in greyscale) while displaying the yellow light.

FIG. 7D illustrates the traffic signal display of FIG. 7A, here, shown in use with all black background (shown here in greyscale) while displaying the red light.

FIG. 7E illustrates the traffic signal display of FIG. 7A, here, shown in use displaying the red light while also displaying desired advertising content, and optionally, additional content such as the time and temperature.

FIG. 8 illustrates an enlarged front face view of preferred alternative traffic signal display of the present invention, similarly to FIG. 5E, wherein the display modularly houses the advertising section, individual modular traffic signal lights and additional content section into the same display panel housing.

### DESCRIPTION OF THE SPECIFIC EMBODIMENTS

It will be appreciated that the present invention may take many forms and embodiments. Some embodiments of the invention are described so as to give an understanding of the invention. It is intended that the embodiments of the invention described herein are to be illustrative and not limiting of the invention.

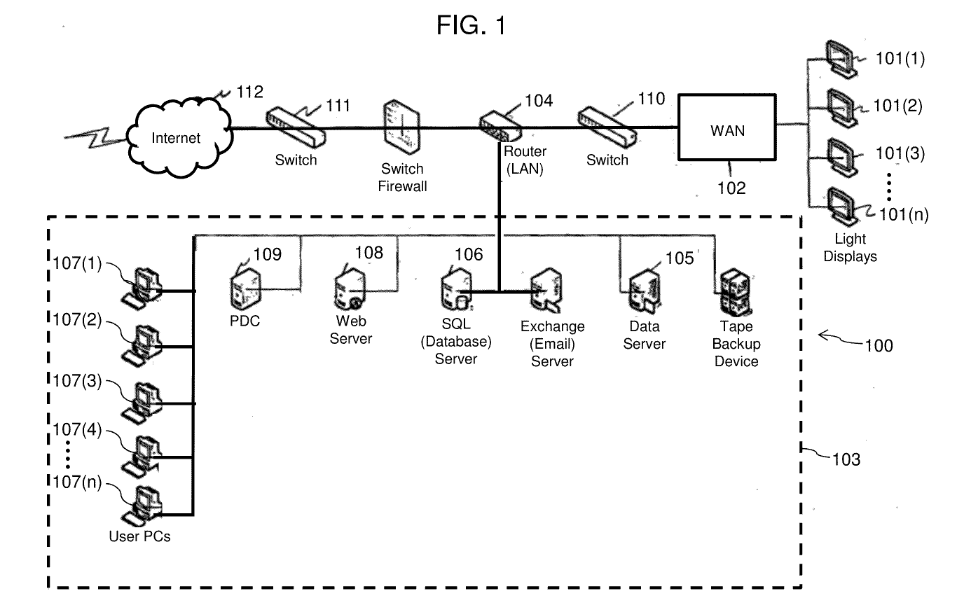

With reference to FIG. 1, a system 100 in accordance with the present invention is illustrated. System 100 comprises a plurality of display computers 101(1), 101(2), 101(3) . . . 101(n). Each such display computer 101(1) through 101(n) includes a display monitor which is associated with a traffic signal and which is mechanically connected to the structure supporting the traffic signal so that the monitor is visible to both vehicular and pedestrian traffic. Each of the display computers 101(1) . . . 101(n) is coupled electronically to a wide area network (WAN) 102, and WAN 102 is the medium utilized in transmitting video information to the display computers 101(1) . . . 101(n). WAN 102 may, for example, be a cable network such as provided by Time Warner.

There are effectively three different types of display monitors that could be used in the system of the present invention. One type of display monitor includes a plasma screen, another type of display monitor includes a liquid crystal display (LCD) screen, and a third type of display monitor includes a light emitting diode (LED) screen. Display monitors having plasma screens or LCD screens appear to be the most advantageous types of screens for use in system in accordance with the present invention.

System 100 in accordance with the present invention also comprises local area network (LAN) 103 which stores and provides video and other information to the display computers 101(1) . . . 101(n) via WAN 102. A router 104 is operatively connected between the LAN 103 and the WAN 102, and the function of router 104 is to direct video information from the LAN 103 to the appropriate display computers 101(1) . . . 101(n) via WAN 102.

The LAN 103 of a system in accordance with the present invention may comprise a first server 105 which is a data server comprising a plurality of storage devices for storing files comprising the video information which is to be transferred to at least one of the display computers 101(1) . . . 101(n) and which is to be displayed on the display monitor associated with that display computer. A system in accordance with the present invention further comprises a second server 106 which is a database server containing files comprising the schedule for display of the files containing video information on the display monitors associated with display computers 101(1) . . . 101(n).

The LAN 103 of system 100 in accordance with the present invention may further comprise a third server [heartbeat server] for receiving information from the display computers 101(1) . . . 101(n) and for processing that information to ensure that the display computers are functioning properly. In one embodiment, each display computer 101(1) . . . 101(n) generates a signal to the third server when the display computer is properly functioning. If that signal is not received by the third server, a technician is alerted.

In accordance with the present invention, each of the display computers 101(1) . . . 101(n) is programmed to interrogate the database in the second or database server for the time, date, name of the video file and location of the video file on the first server; to retrieve the video files from the first server based upon the information received from the second server and to display the retrieved file on the display monitor associated with that display computer.

The LAN 103 of a system 100 in accordance with the present invention may further comprise a plurality of user computers 107(1), 107(2), 107(3), 107(4), . . . 107(m), where m=the number of authorized users. These user computers allow users to provide information to the second server respecting schedules for display of video information and also provide information to the first server respecting the video information to be displayed.

In one embodiment of the present invention, each of the user computers 107(1) . . . 107(m) may be programmed to receive input from a user of the time and date to display a given video or other digital content file on a particular display monitor; to provide information for storage in the database of the second server respecting the time, date, video file name and location on the first server of the video file and the name of the display computer to display that video file; and to provide the storage devices of the first server with the video file to be displayed on one of the display monitors.

In a system 100 in accordance with the present invention, each user computer 107(1) . . . 107(m) may further be programmed to interrogate the information in the database of the second server respecting schedules for display of video information and to display that schedule information on the user computer. Additionally, each user computer 107(1) . . . 107(m) may be further programmed to retrieve files respecting video information from the first server and to display those files on the user computer.

In one embodiment of a system 100 in accordance with the present invention, the LAN 103 further comprises active directory server 109. This server 109 maintains a directory of authorized users of the system. Once a user enters his or her password into the system, the active directory server 109 permits all applications and services for which the user has been enabled to be available to the user.

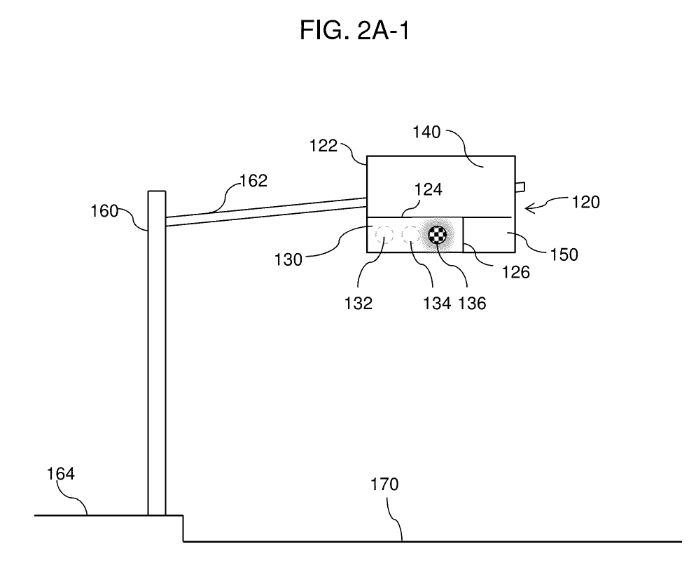

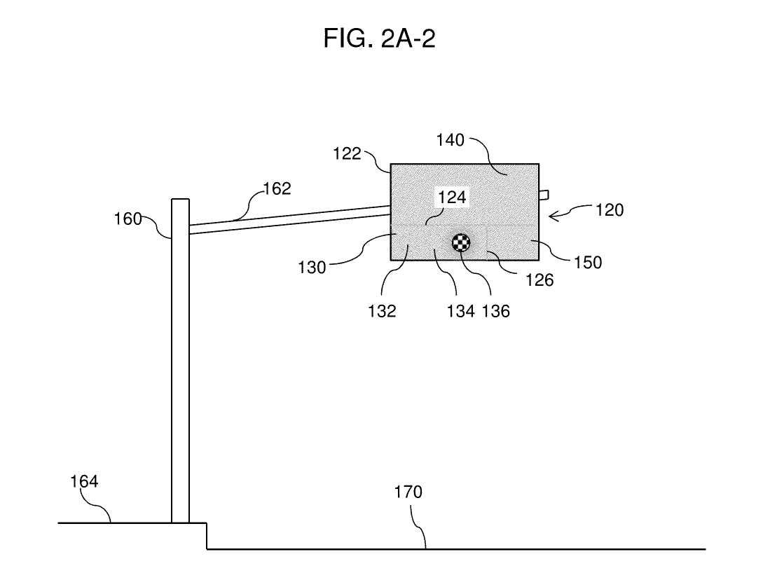

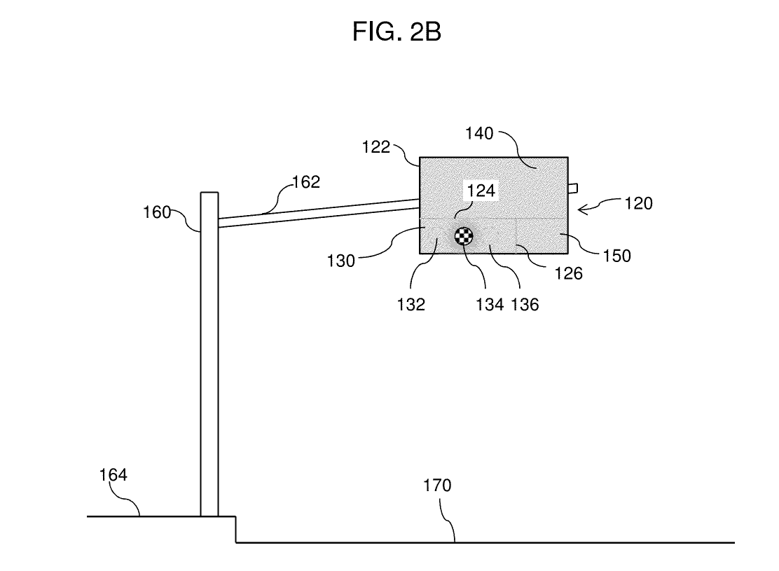

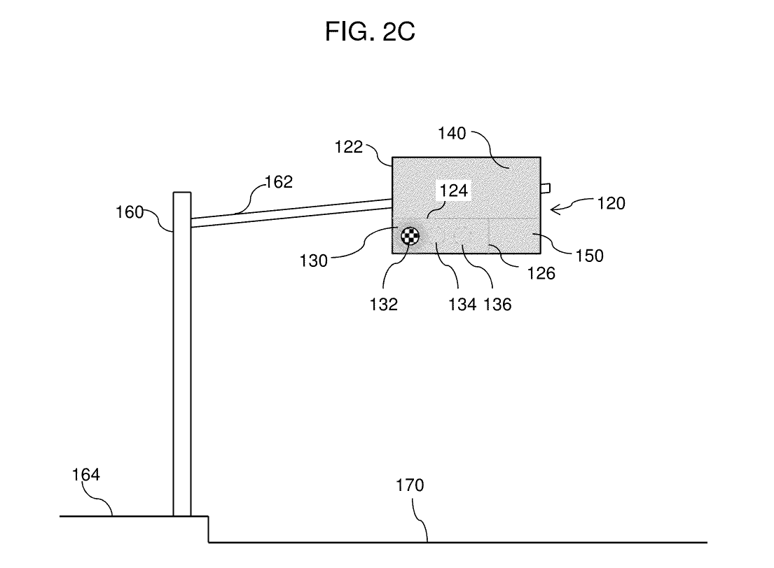

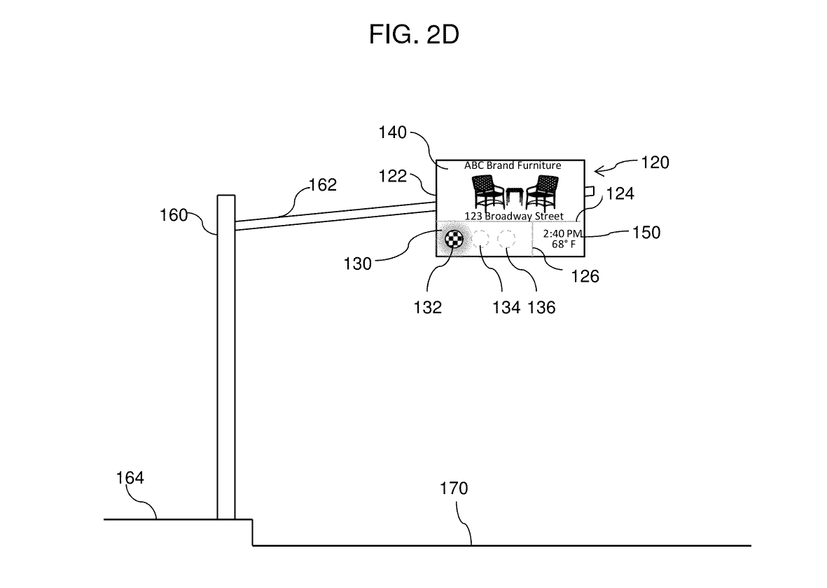

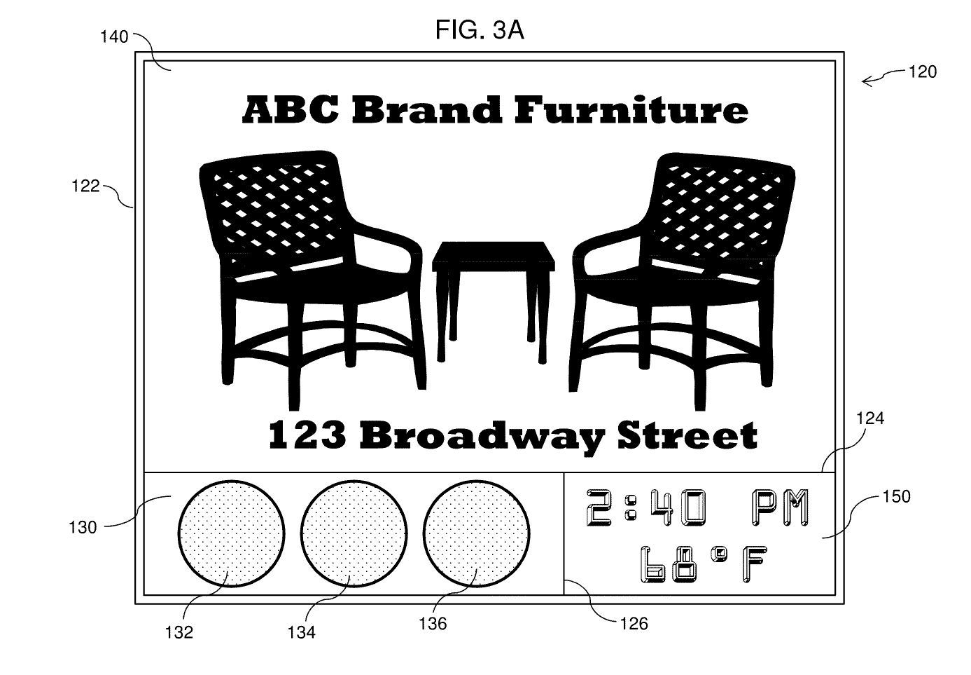

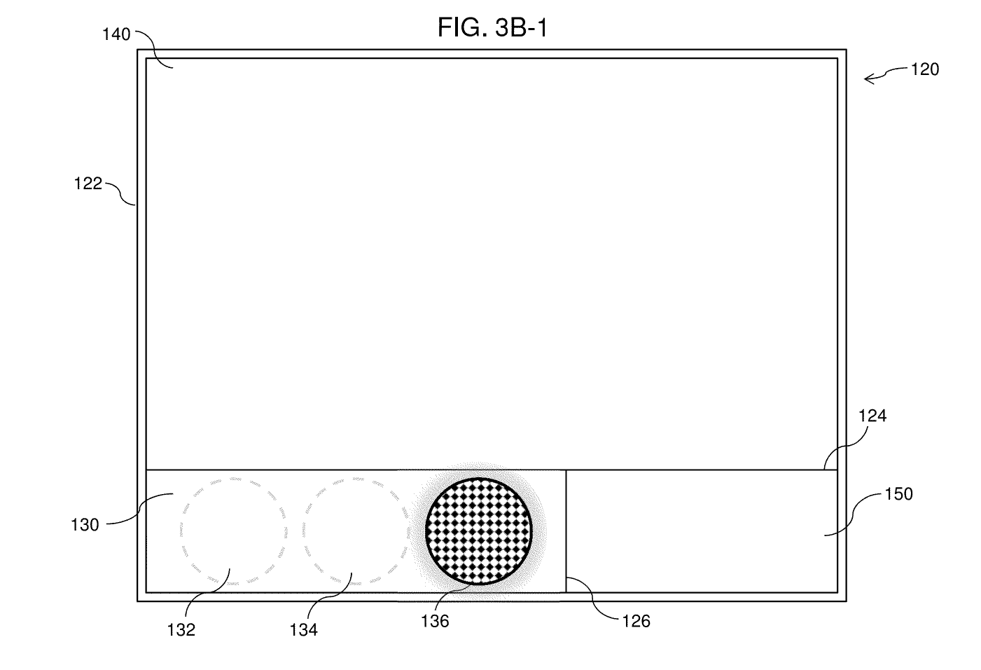

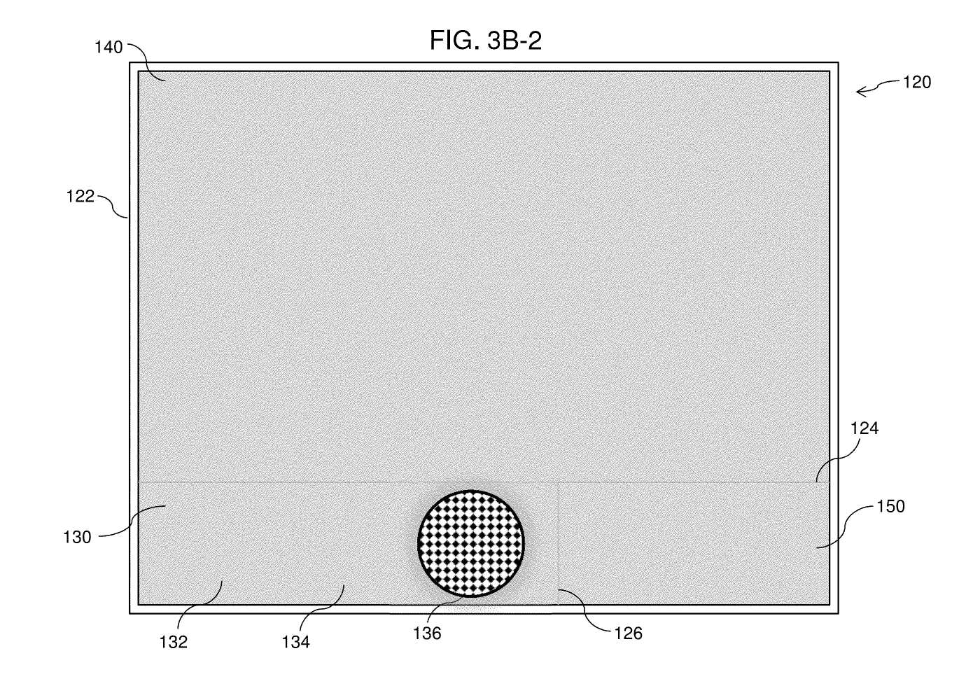

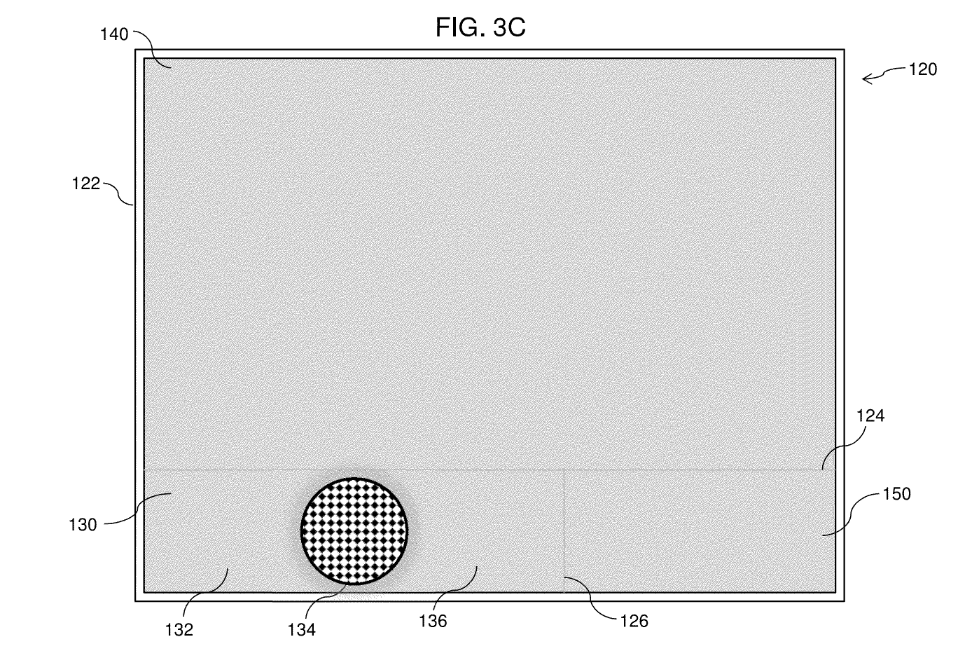

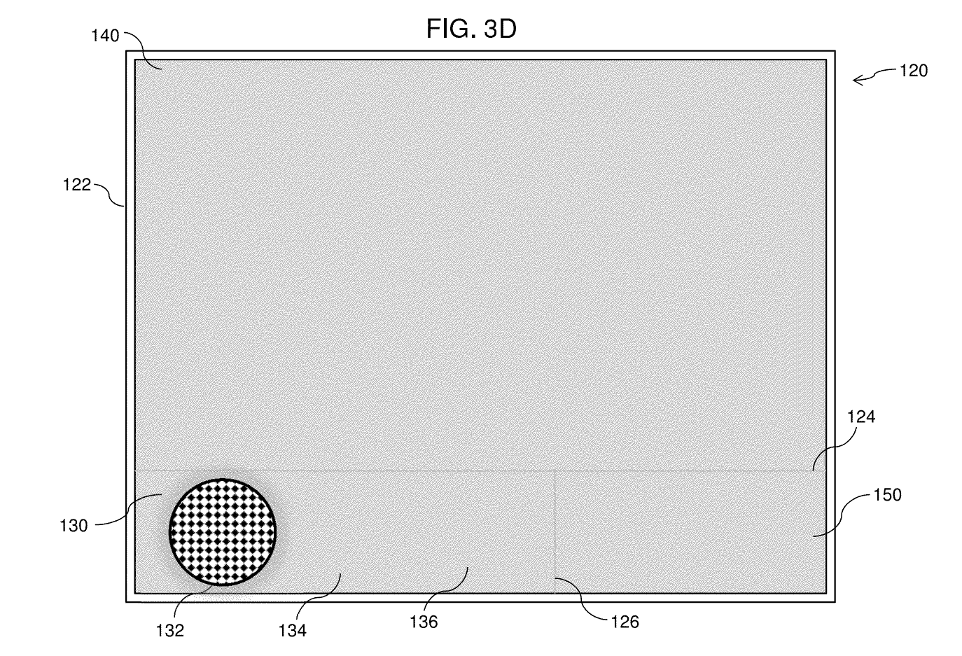

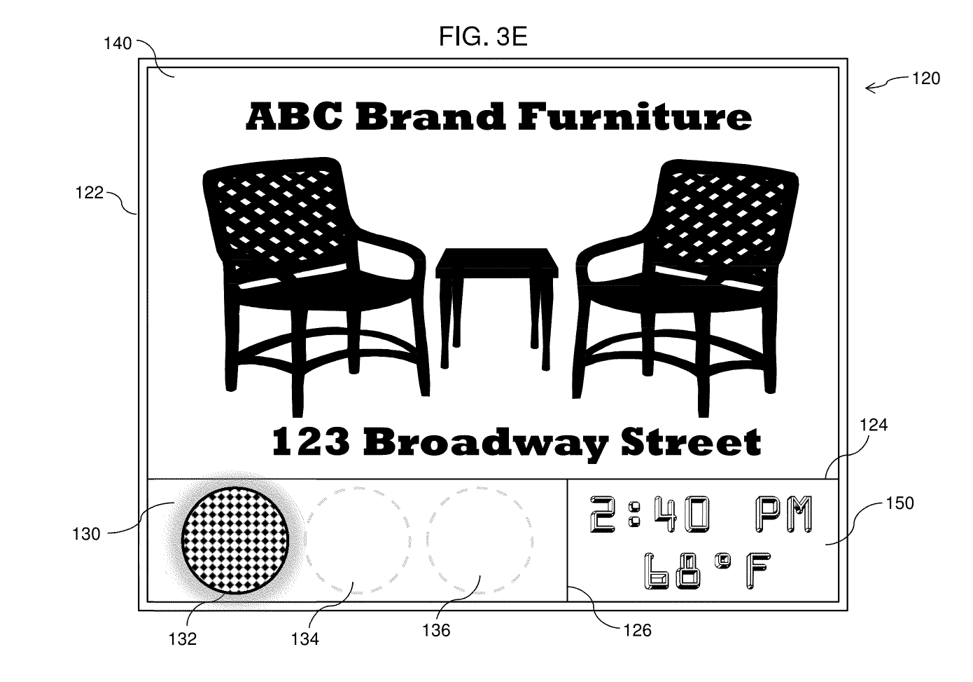

Referring now to FIG. 2A-1, there is illustrated a preferred traffic signal display 120 of the present invention suitable mounted (via mounts known in the art) to a traffic signal pole 160 (mounted in, e.g., a sidewalk or curb area 164). Here, specifically, the traffic signal display 120 is mounted to the horizontal arm 162 of the traffic signal pole 160 in an area over the roadway or street 170 (other suitable traffic signal mounting locations are well understood in the art). FIG. 3A illustrates an enlarged front face view of preferred traffic signal display of the present invention, such as that shown in FIG. 2A-1, wherein the display 120 modularly houses the advertising section 140 (for displaying desired digital advertising content, whether video or digital images in nature), traffic signal section 130 and additional content section 150 into the same display panel housing 122.

The traffic signal unit 120 comprises a housing 122, an advertising content display screen section 140, a traffic signal display section 130 (capable of displaying desired traffic signal lights, e.g., red light 132, yellow light 134 and green light 136), and an additional content display section 150, for displaying, e.g., the time and temperature. In this embodiment, the advertising content display screen section 140 is mounted within housing 122 above the traffic signal light section 130 and additional content section, 150 (if optionally desired), each section being separated by housing dividers 124 and 126 to permit modular installation and maintenance of each section within housing 122. Preferably, each section (140, 130, 150) is independently weather-proofed to permit plug and play installation into and removal from (for, e.g., repair, maintenance or replacement) the housing 122 of any desired section.

The housing 122 is configured to contain the traffic signal section 130, advertising content section 140 and (as optionally desired) the additional contents section 150. The housing may contain a weather-proofed enclosure to house the various display screen sections so that the display screen faces outward and in the direction of the oncoming traffic approaching the intersection. The housing is mounted on the traffic signal pole using any of the available mounting technologies known in the art. The modularity of the unit 120 of some of the embodiments is particularly useful if maintenance or repair is required, so that, e.g., if only the signal light section 130 requires repair, then it could quickly be removed and replaced (and the malfunctioning unit could be taken back for repair).

Referring now also the series of FIGS. 2 and 3, FIG. 2A-2 and FIG. 3B-2 illustrate the traffic signal display 120 shown in use with all black background while displaying only the green light 136. FIG. 3B-1 shows the same, but without the black background for the ease of depicting the features. FIG. 2B and FIG. 3C illustrate the traffic signal display 120 shown in use with all black background while displaying only the yellow light. FIG. 2C and FIG. 3D illustrate the traffic signal display 120 shown in use with all black background while displaying only the red light 132. FIG. 2D and FIG. 3E illustrate the traffic signal display 120 shown in use displaying the red light while also displaying desired advertising content in the advertising content section 140, and optionally, additional content such as the time and temperature in the additional content section 150.

When the green light 136 and yellow light 134 are illuminated, the content of the advertising section 140 and additional information section 150 are programmed to be blank (preferably solid black screen) so that the viewer only sees the traffic signal light within the display device 120 up against a uniformly black background. Likewise, initially when the signal light advances from yellow light 134 condition to red light 132 condition, the content of the advertising section 140 and additional information section 150 are programmed to be initially blank (preferably solid black screen) for a prescribed period of time delay so that the viewer only sees the red traffic signal light within the display device 120. Thus, at the conclusion of the red light condition, the screens 140, 150 will go blank (black) and only the green light 136 will be illuminated. Likewise, the remainder of the signal light section 130 preferably will go blank (black) during the green light condition. It is preferred that during operation, only the active signal light (red, green or yellow) is illuminated at a time, and that the remainder of the signal light section remains blank (black) except for the signal light that is currently in use.

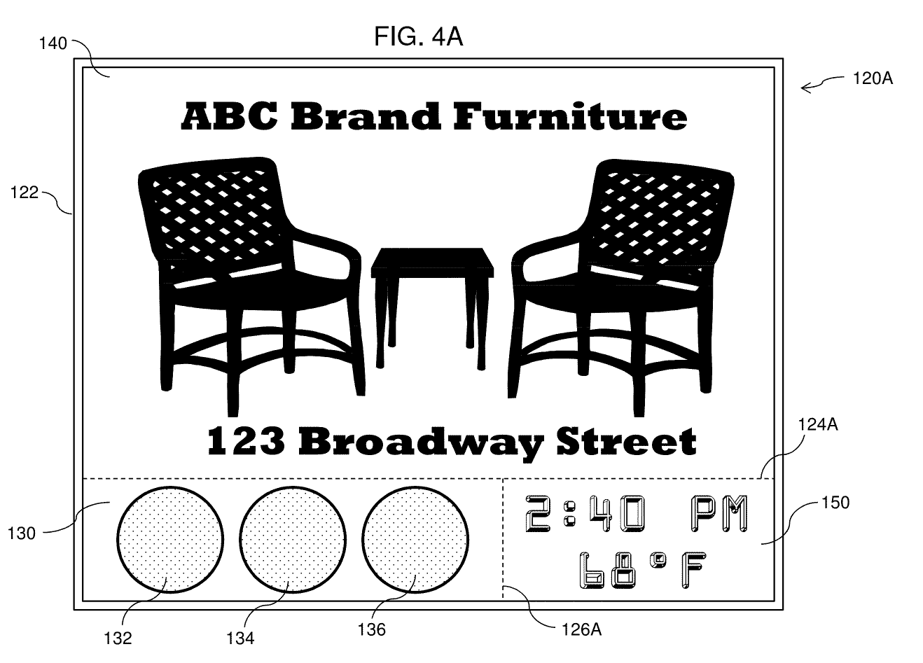

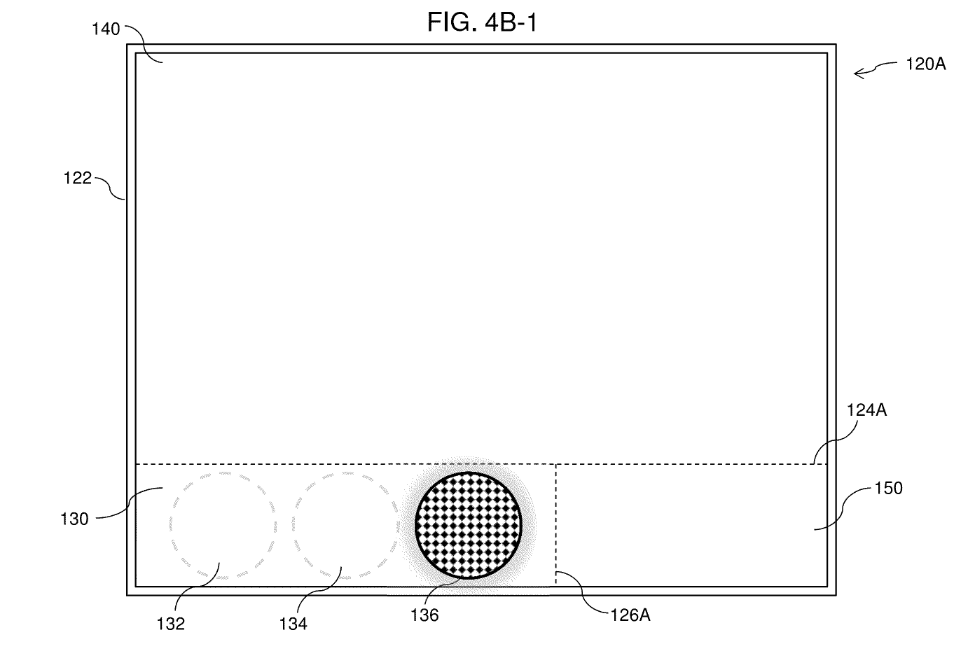

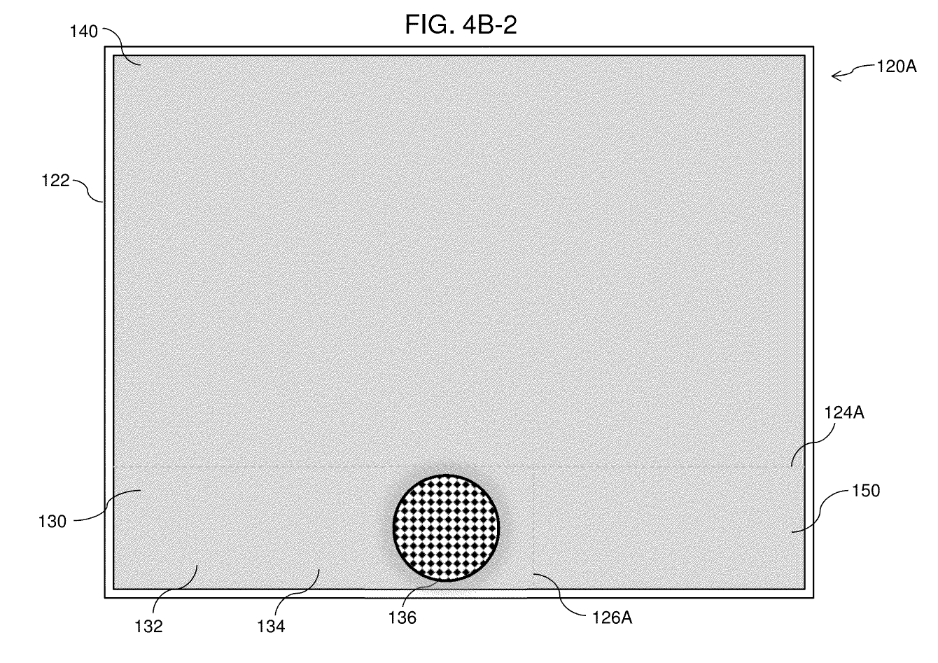

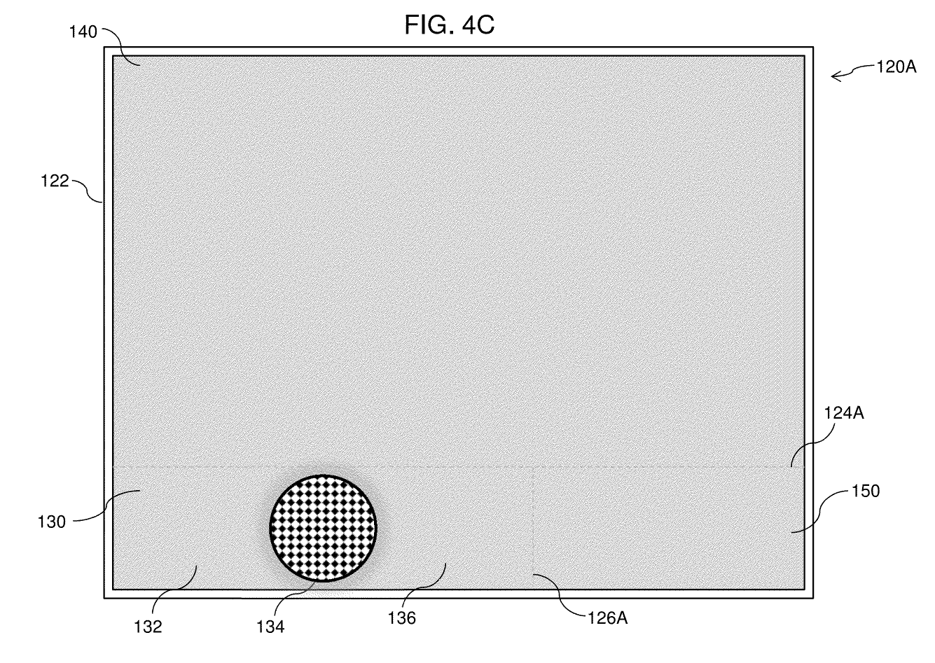

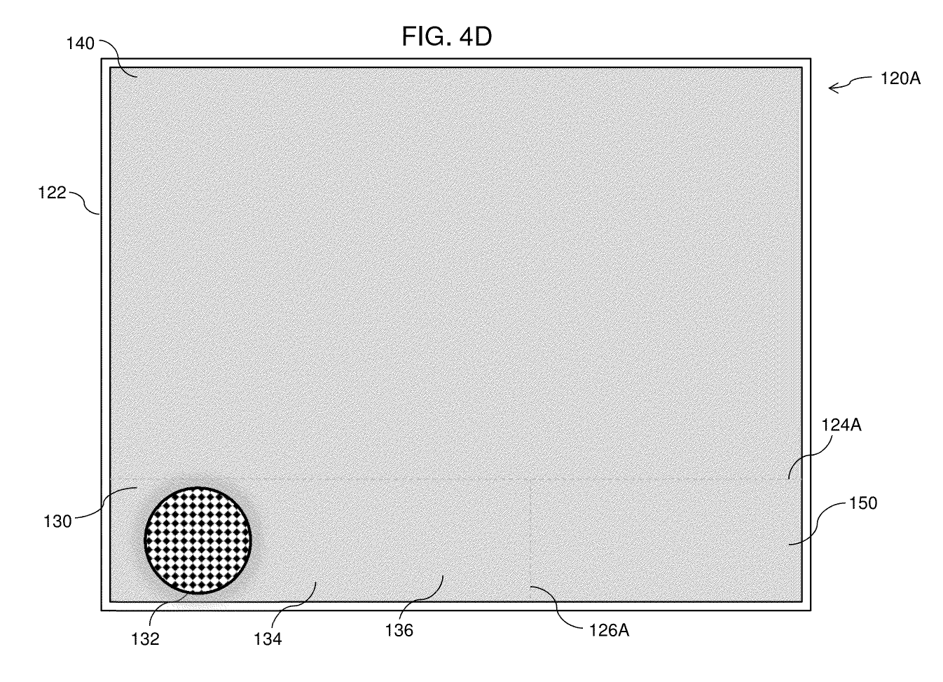

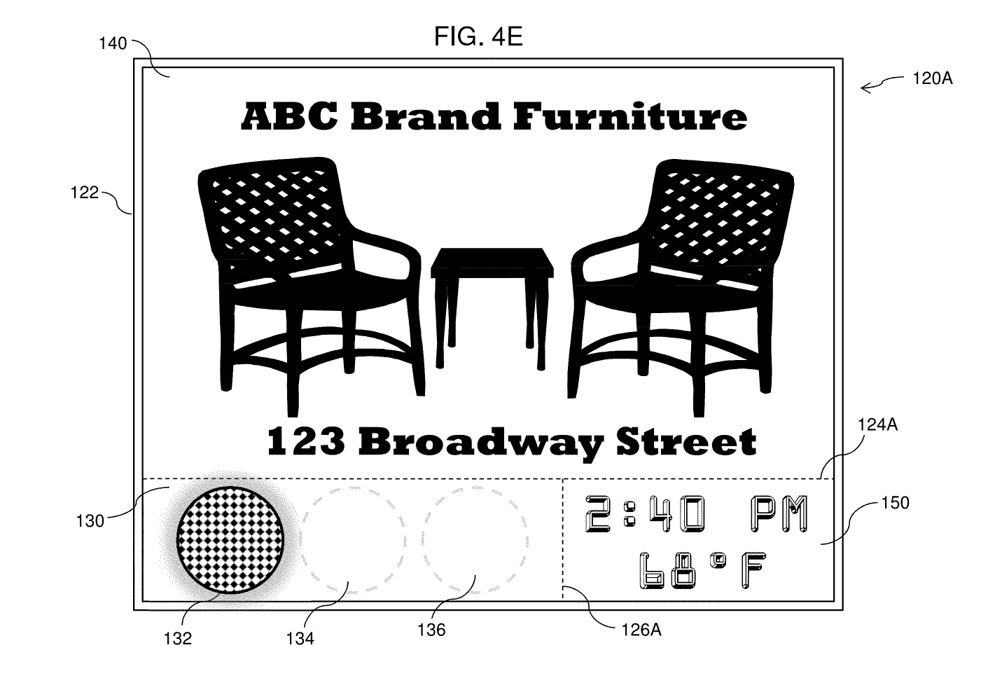

FIG. 4A illustrates an enlarged front face view of an alternative preferred traffic signal display 120A of the present invention wherein the display 120A incorporates the advertising content section 140, traffic signal content section 130 and additional content section 150 into the same display screen. Dividers 124A and 126A are not physical dividers, but are used here to illustrate the various sections of the display screen component of the display device 120A. FIGS. 4A-4E are similar to those in FIGS. 3A-3E, except rather than having each section (140, 130, 150) be a modular addition to the housing 122 (of FIG. 3A), the sections (140, 130, 150) of FIG. 4A are incorporated into the same display screen of the display device 120A.

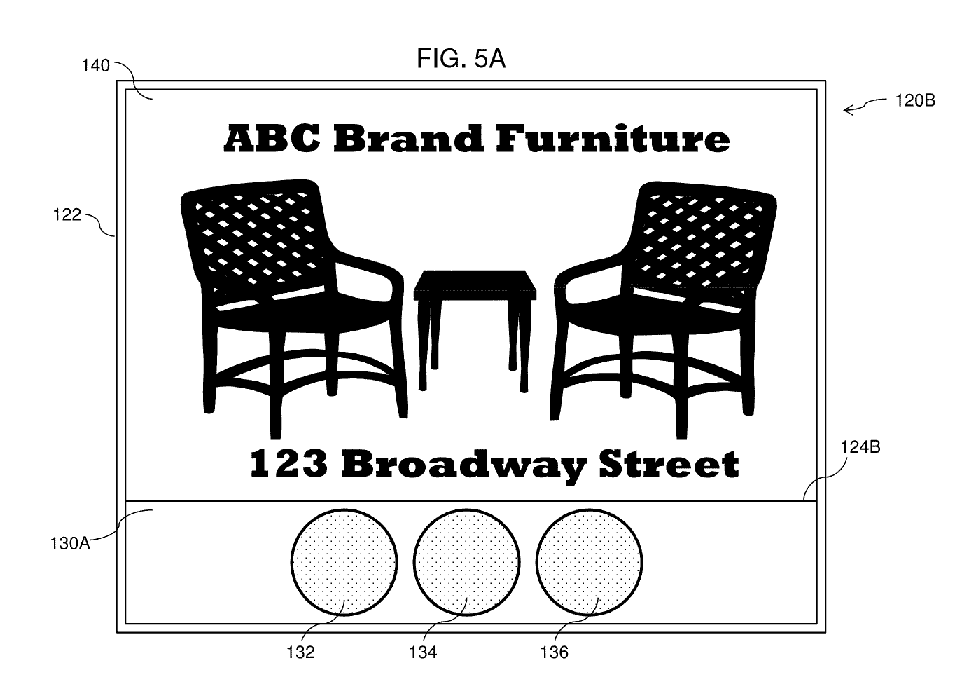

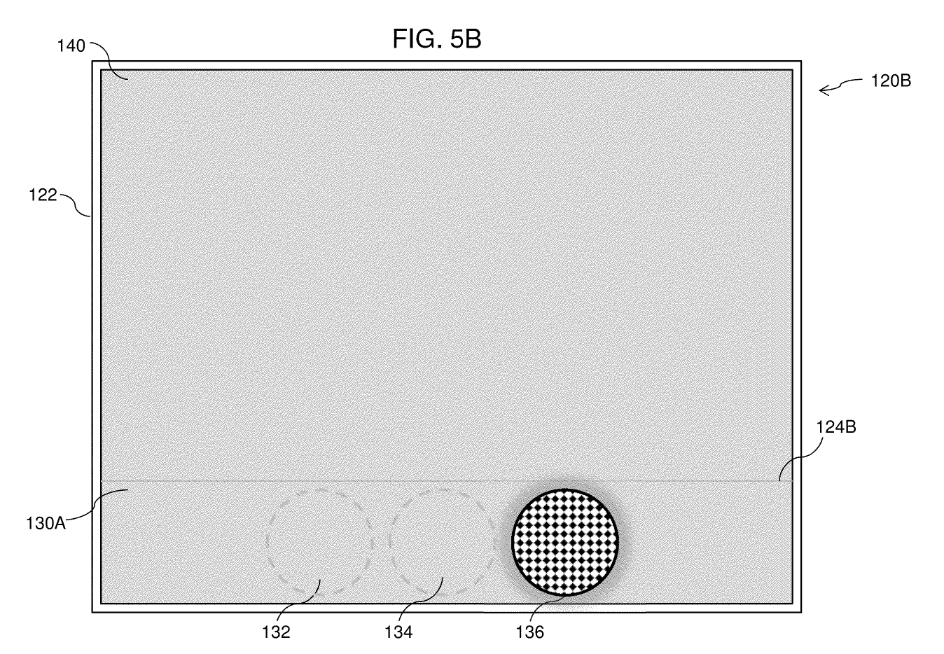

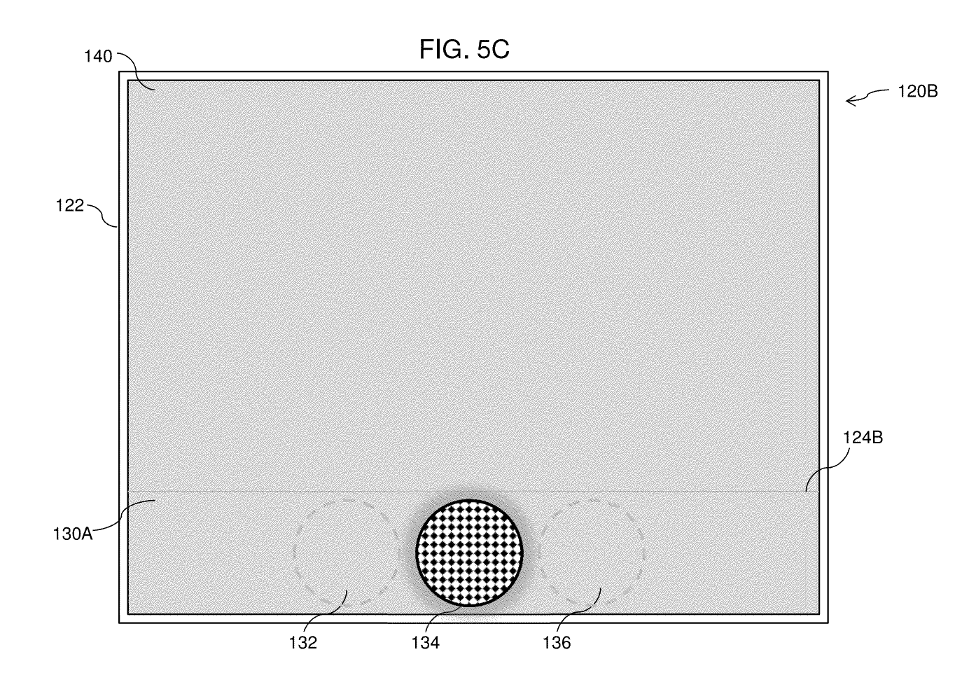

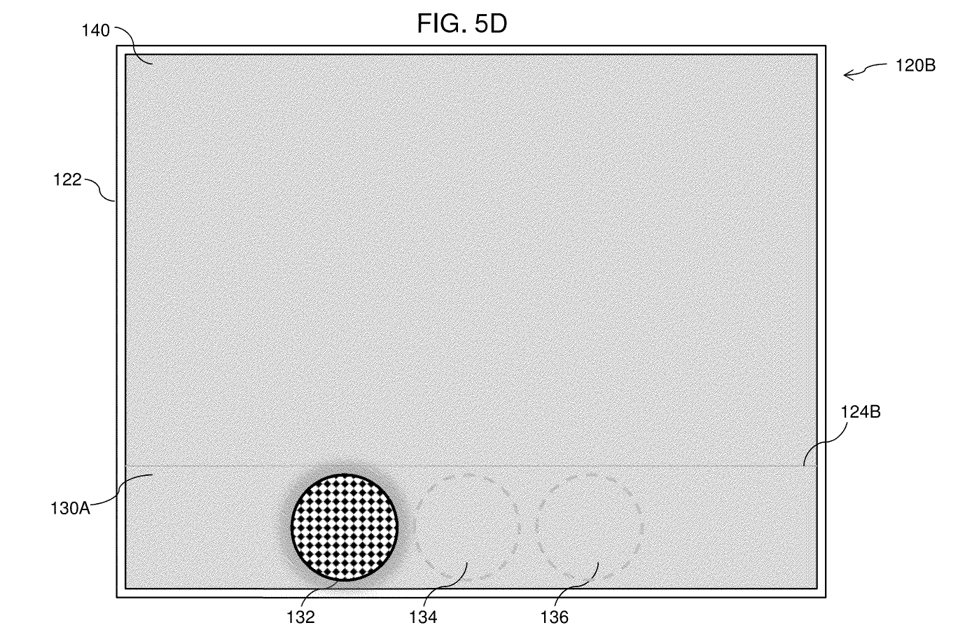

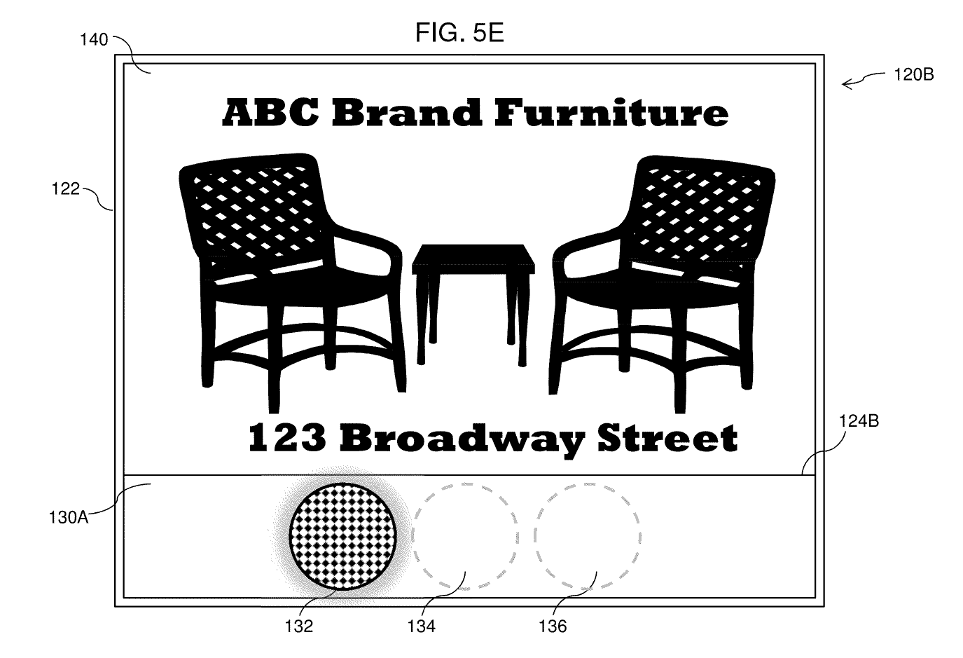

FIG. 5A illustrates an enlarged front face view of an alternative preferred traffic signal display 120B of the present invention, wherein the display incorporates the advertising content section module 140 and traffic signal content section module 130A into the same display screen housing, separated by divider 124B. In this embodiment, preferably the signal lights (132, 134, 136) are centered directly beneath the advertising content section module 140. FIG. 5B illustrates the traffic signal display 120B of FIG. 5A, here, shown in use with all black background while displaying the green light 136. FIG. 5C illustrates the traffic signal display of FIG. 5A, here, shown in use with all black background while displaying the yellow light 134. FIG. 5D illustrates the traffic signal display of FIG. 5A, here, shown in use with all black background while displaying the red light 132. FIG. 5E illustrates the traffic signal display of FIG. 5A, here, shown in use displaying the red light 132 while also displaying desired advertising content in the advertising content module 140.

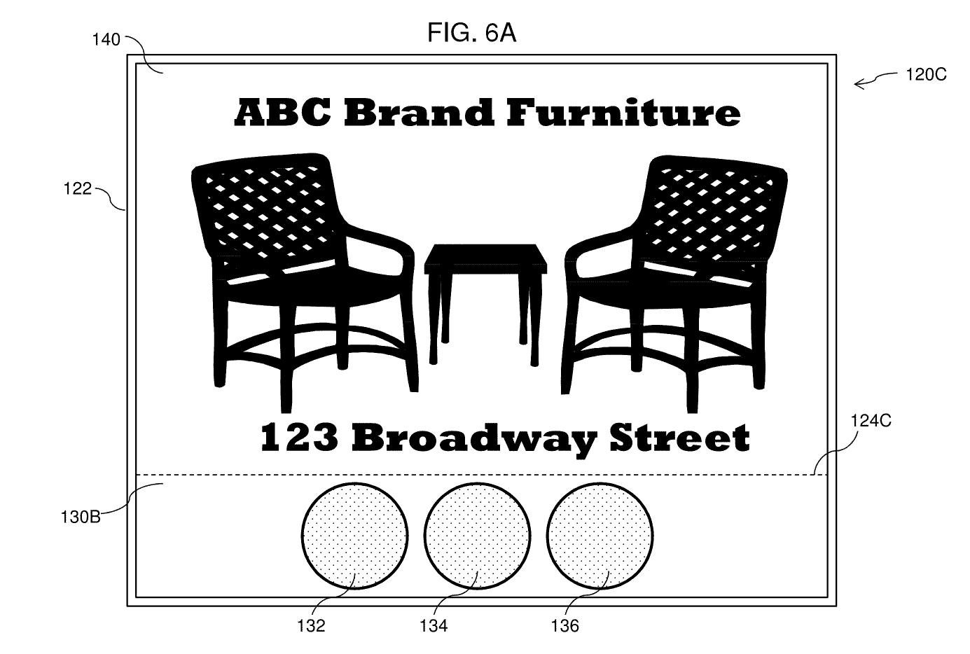

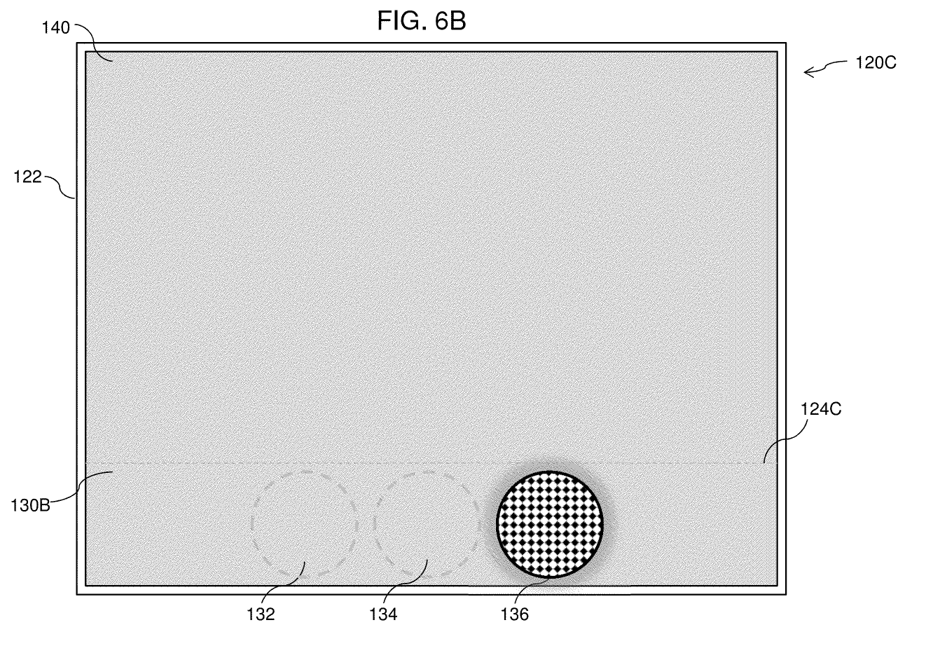

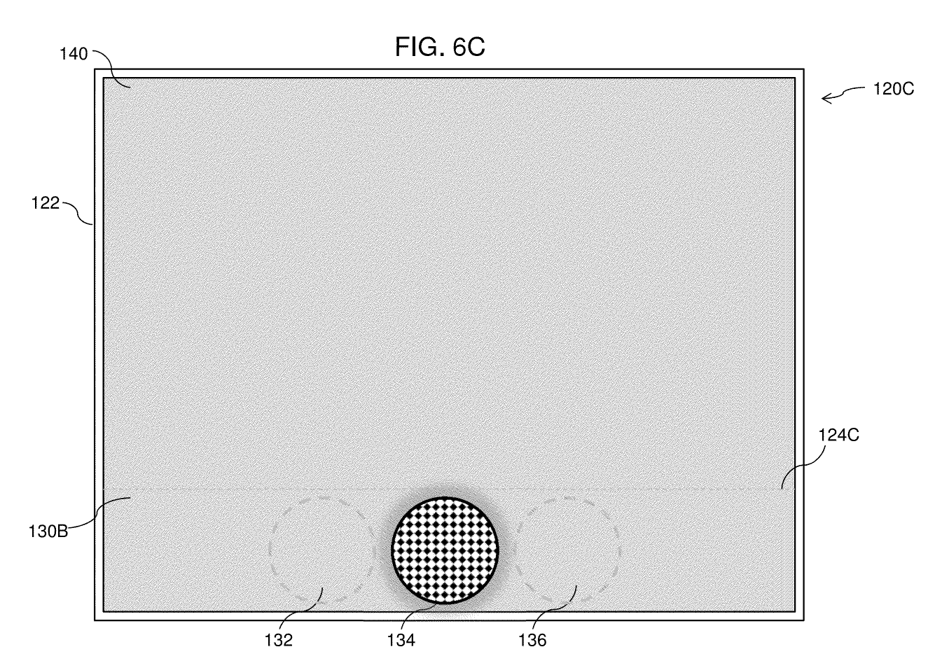

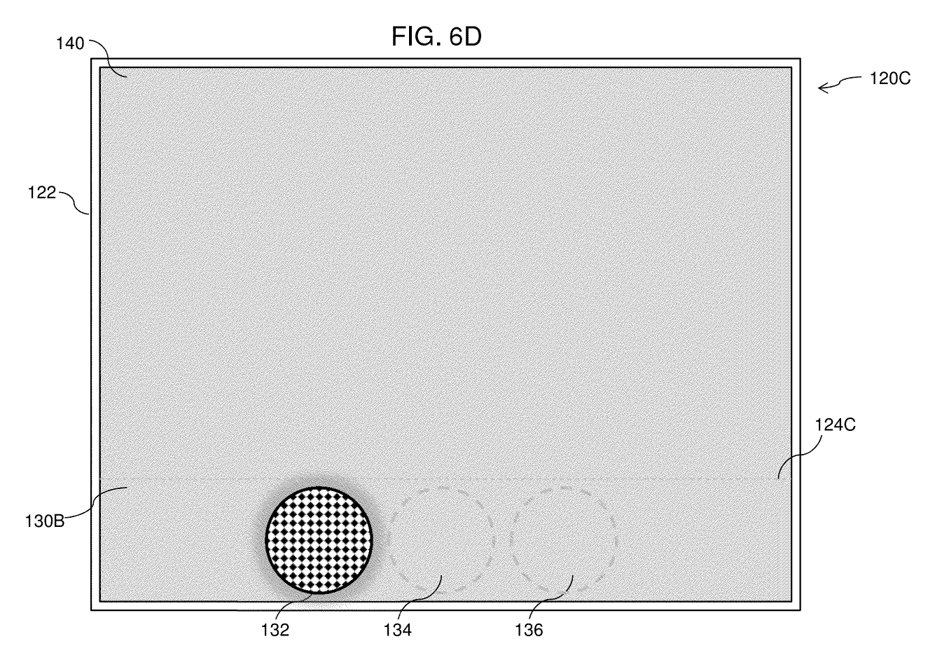

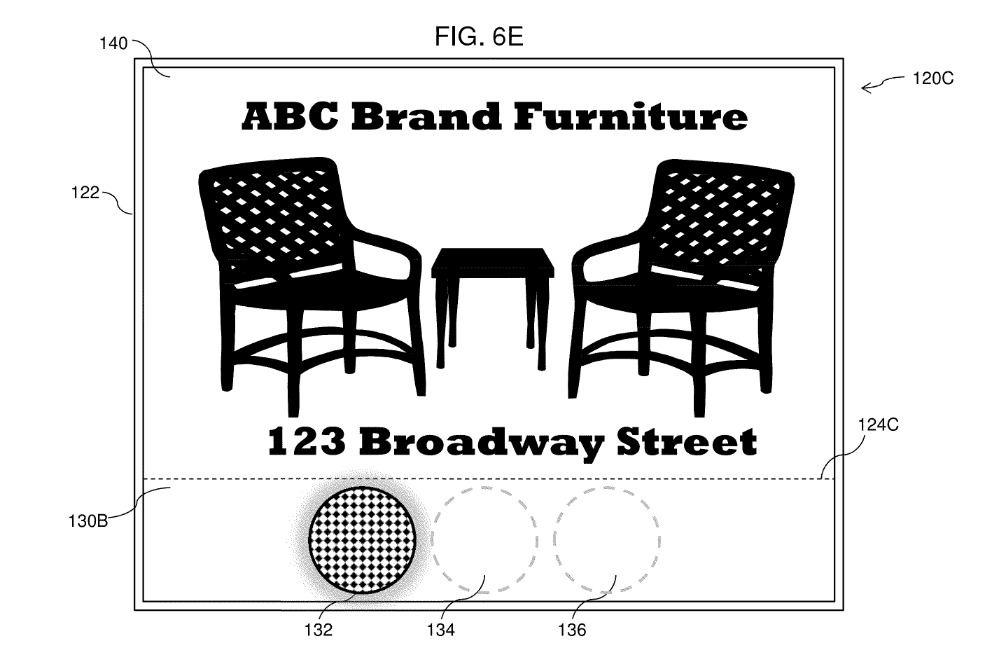

FIG. 6A is similar to that of FIG. 5A except that it illustrates an enlarged front face view of an alternative preferred traffic signal display 120C of the present invention, wherein the display incorporates the advertising content section 140 and traffic signal content section 130B into the same display screen within housing 122. The divider 124C is not a physical divider, but is shown to illustrate the two sections (140, 130B). Otherwise, the operation of the embodiment of FIGS. 6A-6E is similar to that of FIGS. 5A-5E.

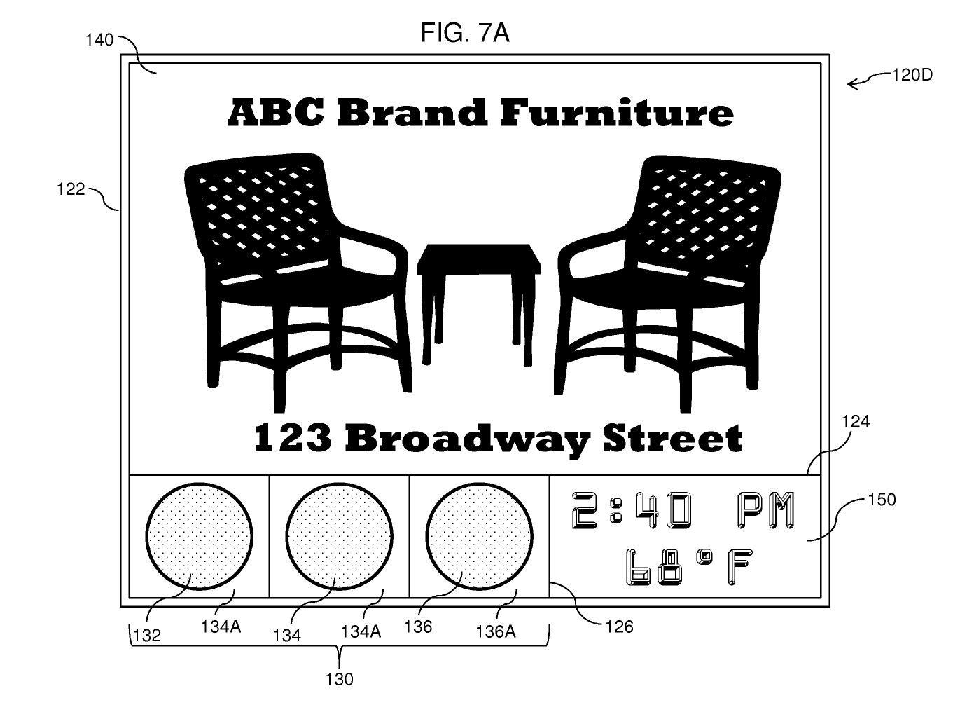

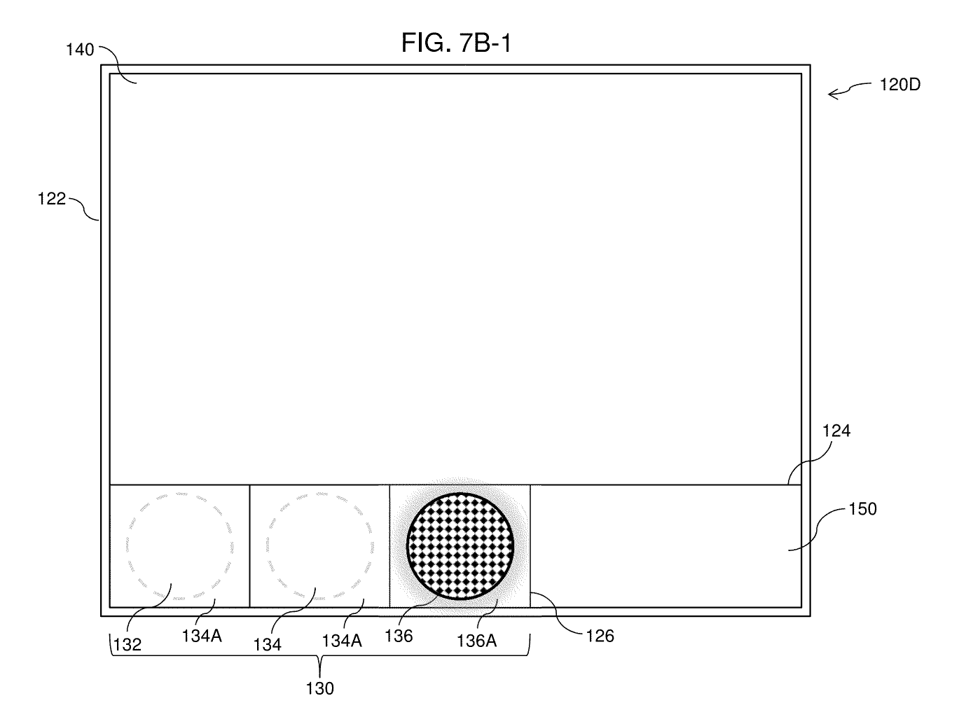

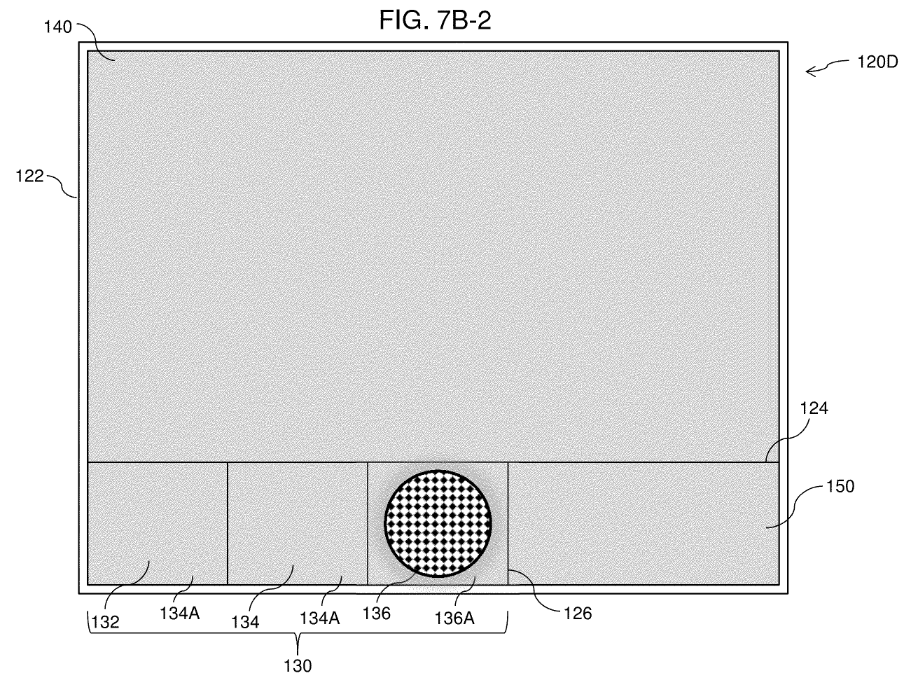

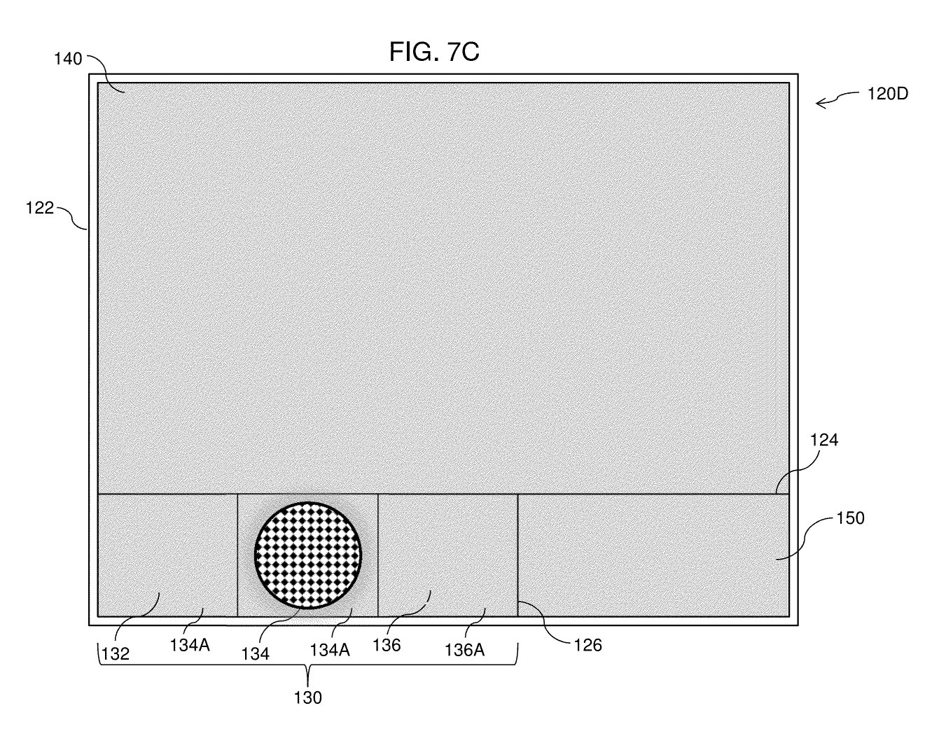

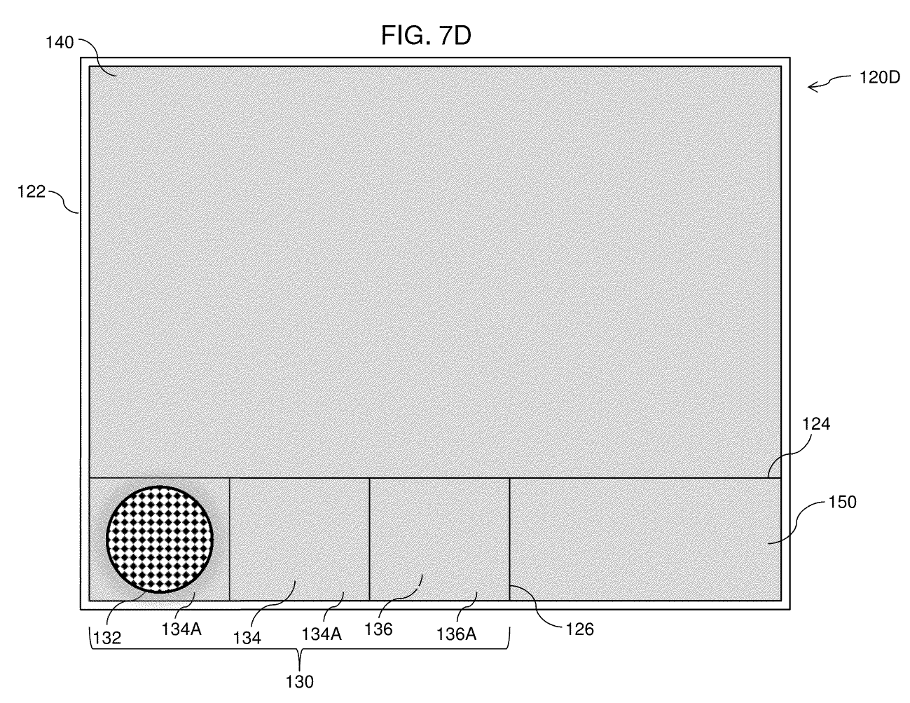

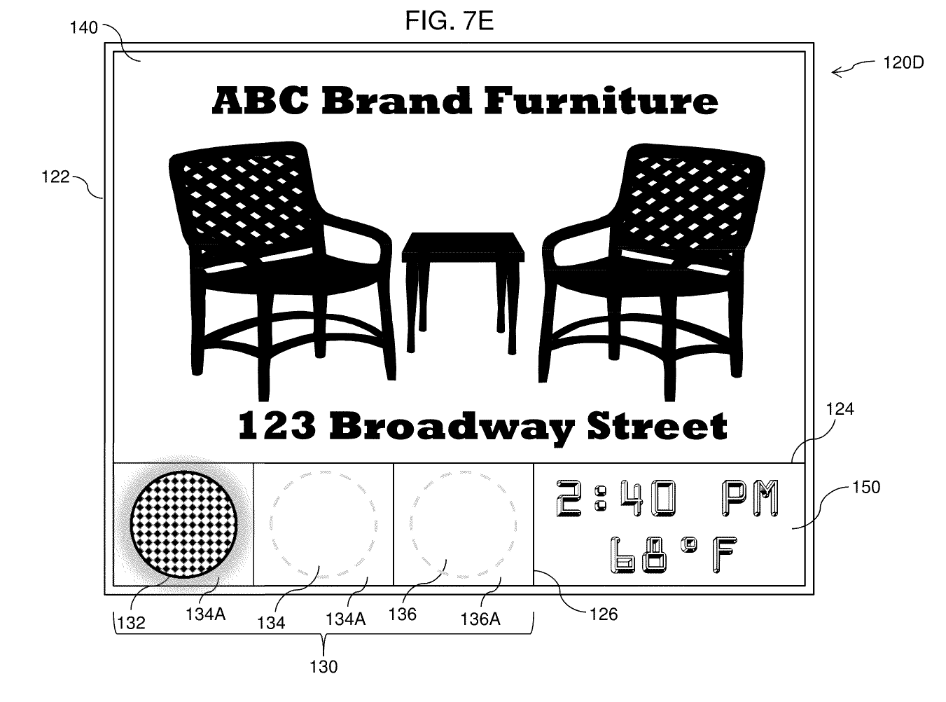

The embodiment illustrated in FIGS. 7A-7E is similar to that of FIGS. 3A-3E except that in FIGS. 17-7E, the traffic signal section 130 is divided into separately-housed modules for each of the lights, e.g., red light module 132A, yellow light module 134A and green light module 136A.

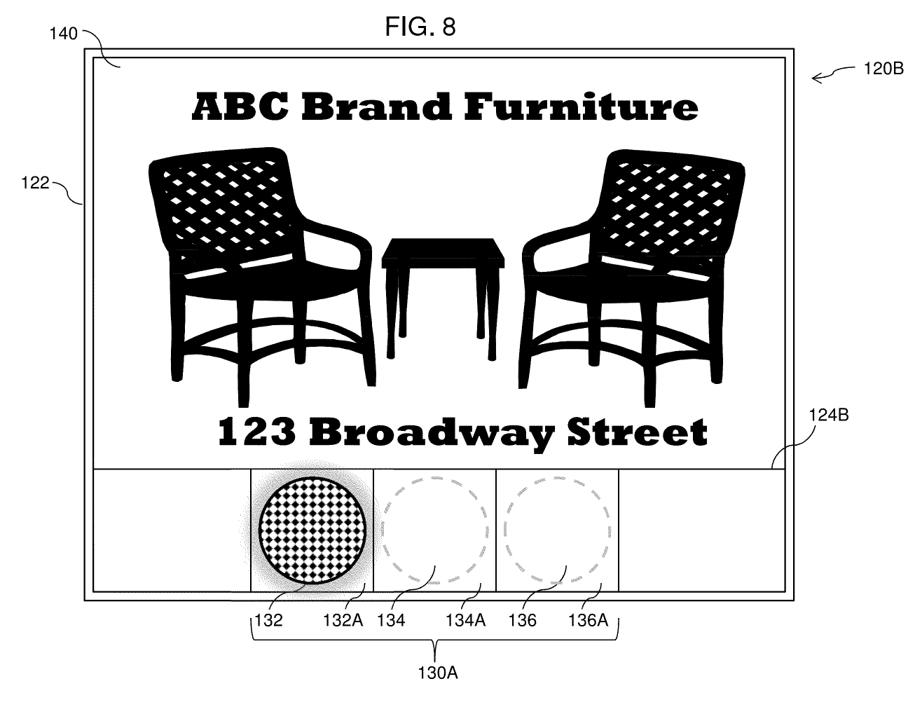

The embodiment illustrated in FIG. 8 is similar to that of FIG. 5E except that in FIG. 8, the traffic signal section 130A is divided into separately-housed modules for each of the lights, e.g., red light module 132A, yellow light module 134A and green light module 136A.

In one embodiment of the present invention, the traffic signal module may comprise existing traffic signal devices that may be mounted within the housing 122. Further, where an existing horizontal traffic signal is in place, the display device 120 and associated housing 122 may be mounted around the existing traffic signal as a retrofit kit. In other embodiments, the display device is constructed with the advertising section 140, signal light section 130 and (optionally) other information section 150 as a single unit and then mounted to the end location (e.g., traffic signal pole) and connected (hardwired or wireles sly) to the appropriate traffic signal communication and advertising/other content controls (e.g., system 100) or the like to suitably control the timing and sequencing of the traffic signal lights with the timing, sequence and content of the advertising or other content (e.g., time, temperature, Amber alerts, weather alerts, traffic alerts) screens 140, 150. The units 120 may be powered by existing electrical lines available at the existing traffic signal light (being replaced or modified by the present invention) and/or could rely, as appropriate, on one or more solar energy cells/panels mounted on the signal light poles to provide a source of energy. The units 120 are preferably weather and impact resistant, contain anti-glare display screens, and are as light weight as possible.

In one embodiment, the display screens are all LED screens, but other existing or future outdoor display screens are and would be suitable for the present invention. In one embodiment, the red light module comprises only red LED lights (rather than by being created with the output from various colored LED lights). In one embodiment, the yellow light module comprises only yellow LED lights (rather than by being created with the output from various colored LED lights). In one embodiment, the green light module comprises only green LED lights (rather than by being created with the output from various colored LED lights). In one embodiment, the housing 122 contains two or more display devices.

Table 1 lists a set of exemplary specifications an outdoor color display device suitable for use in the present invention.

TABLE 1
Example Specifications for Outdoor Full Color Display, 62″ w ×
31.5 h, P10 RGB, Out Door, one side:

| List | Item | Description |
|---|---|---|
| 1 | Pixel Pitch | 10 mm |
| 2 | Module Size | 160*160 mm |
| 3 | Pixel Density | 10000/m² |
| 4 | Pixel Composition | IRIGIB |
| 5 | LED Type | DIP346 |
| 6 | Module Resolution | 16*16 |
| 7 | Power Consumption of | 24 W |
| | Module | |
| 8 | The Optimum Viewing | 10~100 m |
| | Distance | |
| 9 | The Optimum Viewing | 110°/70° |
| | Angle | |
| 10 | Maximum Power | 920 W/m² |
| | Consumption | |
| | Maximum Power | 1200 W/whole display |
| | Consumption | |
| | Typical Power | 800 W/whole display |
| | Consumption | |
| 11 | Cabinet Size | 1600*800 mm 62″ × 31.5″ |
| | | 6″ D |
| 12 | Cabinet Resolution | 160*80 |
| 13 | Cabinet Weight | Preferably 35-40 kg |
| | | Waterproof |
| 14 | Driving Method | ¼ Scan Constant Current |
| | | Driving |
| 15 | Frame Frequency | ≧60 Hz/s |
| 16 | Refresh Rate | ≧360 Hz/s |
| 17 | White Balance Luminance | ≧6000 cd/m² |
| | (CD/m²) | |
| 18 | Operating Environment | −20° C. to 60° C. Optional |
| | Temperature | |
| 19 | Operating Voltage | 110 V ± 10% |
| 20 | Grey Scale | Display Colors ≧ 16.7M |
| | | (Synchronized) |
| 21 | Brightness Adjustment | 256 grades of each color |
| | | (R.G.B.) can be adjusted |
| | | manually and 8 levels of |
| | | each color can be adjusted |
| | | automatically |
| 22 | Input Signal | RF, S-Video RF, S-Video, |
| | | RGB, RGBHV, YUV, etc. |
| 23 | Control System | PC + DVI display card + |
| | | main control cart + |
| | | receiver |
| 24 | Average No Failure Time | >5000 Hours |
| 25 | Life-Span | >100000 Hours |
| 26 | Out-of-Control Rate | <0.0001 |
| 27 | Transmitting Distance | Internet cable: <100 m |

Those skilled in the art will appreciate that there a variety of computers, servers and routers that could be used to implement a system in accordance with the present invention. In one embodiment of the present invention, each of the display computers 101(1) . . . 101(n) is a high-end, small form factor type computer. The router 104 in one embodiment of the invention is an integrated software type router. Further, each of the servers in one embodiment of the present invention is a high-end, large capacity type server.

What is claimed is:

1. A system for displaying advertisements on a plurality of display monitors where each said display monitor is associated with and mechanically connected to a traffic signal, comprising:
one or more traffic signal display monitors, each monitor comprising a display monitor housing and one or more display screens for displaying advertising content from an advertising content display section and traffic signals from a traffic signal display content section proximate the advertising content display section;
a plurality of display computers where each said display computer is operatively connected to one of said display monitors for providing video or other digital content information to the display monitor which is to be displayed on the display monitor;
a wide area network which is operatively coupled to said display computers for use in transmitting video and other information to said display computers;
a local area network which provides video and other information to the display computers via the wide area network; and
a router operatively connected between the local area network and the wide area network for directing the video or other digital content information from the local area network to at least one of said display computers.

2. The system of claim 1, wherein the local area network comprises a first server [data server] comprising a plurality of storage devices for storing files comprising the video or other digital content information which is to be transferred to at least one of said display computers and which is to be displayed on the display monitor associated with said display computer.

3. The system of claim 2, wherein the local area network further comprises a second server [database server] containing files comprising the schedule for displaying files containing video or other digital content information.

4. The system of claim 3, wherein the local area network further comprises a plurality of user computers which provide information to said second server respecting schedules and which provide information to said first server respecting the video or other digital content information to be displayed.

5. The system of claim 3, wherein the local area network further comprises a third server [Heartbeat server] for receiving information from a display computer and processing that information to ensure that the display computer is functioning properly.

6. The system of claim 3, wherein each display computer is programmed to: (a) interrogate the database in the second server [database server] for the time, date, name of the video file or other digital content file and location of the video file or other digital content file on the first server [data server]; (b) retrieve video files or other digital content files from the first server based on information received from the second server; and (c) display the retrieval file on the display monitor associated with that display computer.

7. The system of claim 4, wherein each user computer is programmed to: (a) receive input from a user of the time and date to display a given video file or other digital content file on a particular display monitor; (b) provide information for storage in the database of the second server [database server] respecting the time, date, video file name or other digital content file name, location on the first server [data server] of the video file or other digital content file and the name of the display computer to display the video file or other digital content file; and (c) providing the storage device of the first server with the video file or other digital content file to be displayed on one of the display monitors.

8. The system of claim 7, wherein each user computer is further programmed to interrogate the information in the database of the second server [database server] respecting schedules of display of video or other digital content file information and to display that information on the user computer.

9. The system of claim 7, wherein each user computer is further programmed to retrieve files respecting video or other digital content file information from the first server [data server] and to display those files.

10. The system of claim 1, wherein the display monitor housing is substantially rectangular in shape defined by a vertical height and horizontal width, the advertising content display section occupying an upper portion of the monitor housing across the entire width of the housing, the traffic signal display content section residing within the housing below the advertising content display section.

11. The system of claim 10 wherein the traffic signal display section is modularly mounted within the housing and wherein the advertising content display section is modularly mounted within the housing and separated from the traffic signal display section by a divider partition.

12. The system of claim 10 wherein the traffic signal display section and the advertising content display section are displayed on the same display screen within the housing.

13. The system of claim 10 wherein the traffic signal display section and the advertising content display section are displayed on different display screens within the housing.

14. The system of claim 10, further comprising one or more additional content display sections within the housing, the additional content display sections being displayed on the one or more display screens.

15. The system of claim 10, further comprising an additional content display section within the housing next to the traffic signal display section, the additional content display section being displayed on the one or more display screens.

16. The system of claim 1, wherein the traffic signal display section further comprises an existing traffic control signal mounted within the housing.

17. The system of claim 1, wherein the traffic signal display section further comprises separate display modules for displaying each of the respectively colored traffic signals.

18. The system of claim 1, wherein the display monitor housing is substantially rectangular in shape, substantially oval in shape, or substantially circular in shape.
